(19) United States
(12) Patent Application Publication
(10) Pub. No.: US 2023/0219420 A1
(43) Pub. Date: Jul. 13, 2023

(54) AUGMENTED REALITY HEAD-UP DISPLAY SYSTEM FOR VEHICLE, AND VEHICLE

(71) Applicant: NIO TECHNOLOGY (ANHUI) CO., LTD, Hefei City (CN)

(72) Inventors: Liang CHEN, Shanghai (CN); Daoyuan HU, Shanghai (CN)

(21) Appl. No.: 18/150,242

(22) Filed: Jan. 5, 2023

(30) Foreign Application Priority Data
Jan. 5, 2022 (CN) 202210007021.0

(51) Int. Cl. B60K 35/00

(52) U.S. Cl. CPC B60K 35/00; B60K 2370/1529; B60K 2370/177; B60K 2370/21; B60K 2370/23; B60K 2370/334; B60K 2370/744

(57) ABSTRACT

The disclosure relates to the technical field of intelligent devices for vehicles, and particularly provides an augmented reality head-up display system for a vehicle, and a vehicle. The disclosure aims to solve the problem of an augmented reality head-up display system for a vehicle in the prior art usually having a large volume of a head-up controller host, poor heat dissipation of an image projection main optical head, a complex imaging light path, large space requirements for a dashboard, and poor imaging quality. To this end, in the disclosure, the vehicle includes a dashboard, and the augmented reality head-up display system includes an image projection main optical head, a head-up controller host, and a reflective imaging plate. The head-up controller host is arranged inside the dashboard, the image projection main optical head is arranged outside the dashboard, the dashboard is further provided with a light path capable of allowing for light to enter and exit the dashboard, imaging is achieved by means of the combined action of the image projection main optical head, the head-up controller host, the reflective imaging plate and the light path, and the imaging quality is improved.

### CROSS-REFERENCE TO RELATED APPLICATIONS

This application claims the benefit of China Patent Application No. 202210007021.0 filed Jan. 5, 2022, the contents of which are incorporated herein by reference in its entirety.

### TECHNICAL FIELD

The disclosure relates to the technical field of intelligent devices for vehicles, and particularly provides an augmented reality head-up display system for a vehicle, and a vehicle.

### BACKGROUND

With continuous development of science and technology, vehicles are also developing in the direction of intelligent, comfortable and convenient vehicles.

In an augmented reality head-up display system for a vehicle in the prior art, an augmented reality image projection main optical head is usually arranged inside an augmented reality head-up controller host, a complete light path is formed by means of mutual cooperation of the augmented reality image projection main optical head, the augmented reality head-up controller host and a reflective imaging plate, and imaging is performed on the reflective imaging plate, so as to facilitate viewing by a driver.

However, the augmented reality head-up display system for a vehicle in the prior art usually has a large volume of the augmented reality head-up controller host, poor heat dissipation of the augmented reality image projection main optical head, a complex imaging light path, large space requirements for a dashboard, and poor imaging quality.

Accordingly, there is a need in the art for a new augmented reality head-up display system for a vehicle, and a vehicle, in order to solve the above problem.

### BRIEF SUMMARY

In order to solve the above problem in the prior art, i.e., to solve the problem of an augmented reality head-up display system for a vehicle in the prior art usually having a large volume of an augmented reality head-up controller host, poor heat dissipation of an augmented reality image projection main optical head, a complex imaging light path, large space requirements for a dashboard, and poor imaging quality, the disclosure provides an augmented reality head-up display system for a vehicle. The vehicle comprises a dashboard, and the augmented reality head-up display system comprises an augmented reality image projection main optical head, an augmented reality head-up controller host, and a reflective imaging plate. The augmented reality head-up controller host is arranged inside the dashboard, the augmented reality image projection main optical head is arranged outside the dashboard, the dashboard is further provided with a light path capable of allowing for light to enter and exit the dashboard, and light emitted by the augmented reality image projection main optical head is capable of passing through the light path to reach the augmented reality head-up controller host, continuing to pass, through light reflection in the augmented reality head-up controller host, out of the light path to reach the reflective imaging plate, and then achieving augmented reality head-up imaging through reflection of the reflective imaging plate.

In a preferred technical solution of the augmented reality head-up display system for a vehicle as described above, a first instrument is arranged on an outer side of the dashboard, and the augmented reality image projection main optical head is arranged on a back surface of the first instrument.

In a preferred technical solution of the augmented reality head-up display system for a vehicle as described above, the first instrument is configured to be capable of translating or rotating.

In a preferred technical solution of the augmented reality head-up display system for a vehicle as described above, an auxiliary image projection following reflection plate is arranged on the augmented reality head-up controller host, and the light emitted by the augmented reality image projection main optical head passes, through reflection of the auxiliary image projection following reflection plate, out of the light path to reach the reflective imaging plate.

In a preferred technical solution of the augmented reality head-up display system for a vehicle as described above, a feedback camera for auxiliary position adjustment is further provided on a side edge of the augmented reality image projection main optical head.

In a preferred technical solution of the augmented reality head-up display system for a vehicle as described above, the reflective imaging plate is a front windshield; or the reflective imaging plate is a specular reflective film attached to the front windshield.

In a preferred technical solution of the augmented reality head-up display system for a vehicle as described above, the dashboard is an open dashboard, the light path is configured to be provided with a notch and a groove on the open dashboard, and a piece of light transmitting glass is arranged on the notch.

In a preferred technical solution of the augmented reality head-up display system for a vehicle as described above, the augmented reality image projection main optical head is arranged on a fixed structure, a translatable structure, or a rotatable structure on top of a head of a driver.

In a preferred technical solution of the augmented reality head-up display system for a vehicle as described above, the augmented reality head-up controller host has a volume set in an interval ranging from 0.2 L to 5 L.

The disclosure further provides a vehicle, including the augmented reality head-up display system for a vehicle of any one of the above technical solutions.

Those skilled in the art can understand that in the technical solutions of the disclosure, the vehicle includes the dashboard, and the augmented reality head-up display system includes the augmented reality image projection main optical head, the augmented reality head-up controller host and the reflective imaging plate, wherein the augmented reality head-up controller host is arranged inside the dashboard, the augmented reality image projection main optical head is arranged outside the dashboard, the dashboard is further provided with a light path capable of allowing for light to enter and exit the dashboard, and light emitted by the augmented reality image projection main optical head is capable of passing through the light path to reach the augmented reality head-up controller host, continuing to pass, through reflection in the augmented reality head-up controller host, out of the light path to reach the reflective imaging plate, and then forming an augmented reality head-up image through reflection of the reflective imaging plate.

With the above arrangement, the augmented reality head-up display system for a vehicle of the disclosure forms a complete light path by means of cooperation of the augmented reality image projection main optical head, the augmented reality head-up controller host, the reflective imaging plate and the light path, such that the light emitted by the augmented reality image projection main optical head can pass through the light path to reach the augmented reality head-up controller host, continues to pass, through reflection of the augmented reality head-up controller host, out of the light path to reach the reflective imaging plate, and forms a head-up image through reflection of the reflective imaging plate, so as to facilitate viewing by the driver. Moreover, the augmented reality head-up controller host is arranged inside the dashboard, the augmented reality image projection main optical head is arranged outside the dashboard, so as to achieve separate arrangement of the augmented reality image projection main optical head separated from the augmented reality head-up controller host, thereby reducing the volume of the augmented reality head-up controller host, so as to reduce space requirements for the interior of the dashboard, further avoiding the problem of a poor imagining effort caused by poor heat dissipation of the augmented reality image projection main optical head, and reducing the number of reflections of the light emitted by the augmented reality image projection main optical head inside the augmented reality head-up controller host, and simplifying the imaging light path, so as to further ensure high-dynamic and high-pixel imaging quality.

### BRIEF DESCRIPTION OF THE SEVERAL VIEWS OF THE DRAWINGS

An augmented reality head-up display system for a vehicle, and a vehicle of the disclosure are described below with reference to the accompanying drawings. In the figures.

FIG. 1 is a schematic structural diagram of an augmented reality head-up display system for a vehicle in the prior art;

FIG. 2 is a schematic structural diagram of an augmented reality head-up display system for a vehicle of the disclosure; and

FIG. 3 is a partial schematic structural diagram of a vehicle using the augmented reality head-up display system for a vehicle of the disclosure.

### LIST OF REFERENCE SIGNS

1—dashboard; 11—first instrument;
2—reflective imaging plate; 21—front windshield;
3—augmented reality image projection main optical head; 31—feedback camera;
4—augmented reality head-up controller host; 41—auxiliary image projection following reflection plate;
5—light path; 51—notch; 52—groove.

### DETAILED DESCRIPTION

Preferred implementations of the disclosure are described below with reference to the accompanying drawings. Those skilled in the art should understand that these implementations are only used to explain the technical principles of the disclosure, and are not intended to limit the scope of protection of the disclosure. Those skilled in the art can make adjustments according to requirements, so as to adapt to specific application scenarios. For example, although an arrangement position of an augmented reality image projection main optical head is described by arranging the augmented reality image projection main optical head on a back surface of a first instrument as an example in the specification, the arrangement position of the augmented reality image projection main optical head in the disclosure is not limited thereto, as long as the arrangement position enables a complete light path to be formed between the augmented reality image projection main optical head, an augmented reality head-up controller host, a reflective imaging plate and a light path so as to satisfy imaging requirements, and enables the augmented reality head-up controller host to be arranged inside the dashboard, and the augmented reality image projection main optical head to be arranged outside the dashboard, so as to separate the augmented reality image projection main optical head from the augmented reality head-up controller host. For example, the augmented reality image projection main optical head may be arranged on a fixed structure on top of a head of a driver. For another example, the augmented reality image projection main optical head may also be arranged on a translatable structure on top of the head of the driver. For still another example, the augmented reality image projection main optical head may be also arranged on a rotatable structure on top of the head of the driver.

It should be noted that in the description of the disclosure, the term “first” is merely used for descriptive purposes and cannot be understood as indicating or implying relative importance.

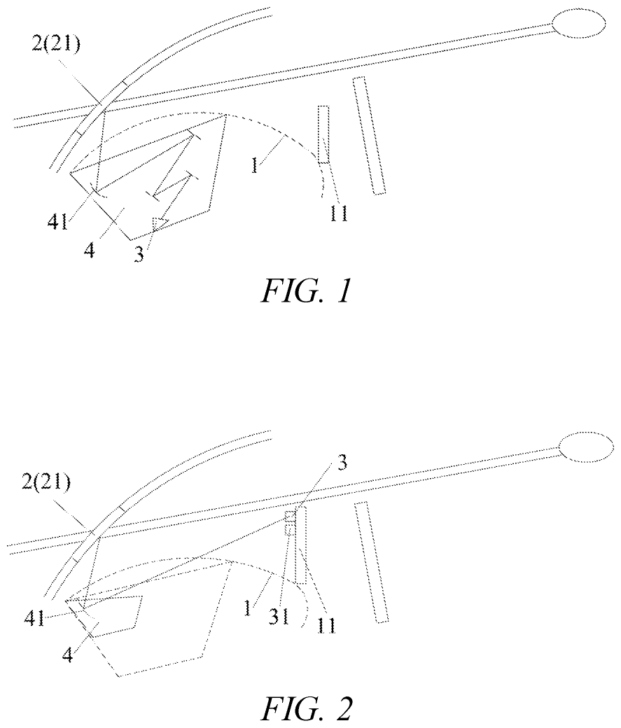

As shown in FIG. 1, in an augmented reality head-up display system for a vehicle in the prior art, an augmented reality image projection main optical head 3 is usually arranged inside an augmented reality head-up controller host 4, a complete light path is formed by means of mutual cooperation of the augmented reality image projection main optical head 3, the augmented reality head-up controller host 4 and a reflective imaging plate 2, and imaging is performed on the reflective imaging plate 2, such that a driver views high-pixel image information in a head-up manner.

In the prior art, the augmented reality image projection main optical head 3 is generally designed to be arranged inside the augmented reality heads-up controller host 4, so that the augmented reality head-up controller host 4 has an increased volume (the volume is usually about 10 L in the prior art), thereby increasing the space requirement for the dashboard 1. Moreover, since the augmented reality head-up controller host 4 constantly generates heats during operation, the augmented reality image projection main optical head 3 has poor heat dissipation and poor performance, and the generated heat also leads to a different internal air temperature and also a different refractive index, thereby reducing the imaging quality. Furthermore, thanks to the fact that the augmented reality image projection main optical head 3 is arranged inside the augmented reality head-up controller host 4, during imaging, light emitted by the augmented reality image projection main optical head 3 needs to be reflected for multiple times inside the augmented reality head-up controller host 4, and is then imaged on the reflective imaging plate 2, thereby increasing the complexity of an imaging light path, and further reducing the imaging quality.

Thus, the disclosure provides a new augmented reality head-up display system for a vehicle. An augmented reality head-up controller host 4 is arranged inside a dashboard 1, and an augmented reality image projection main optical head 3 is arranged outside the dashboard 1, to achieve a separate arrangement of the augmented reality image projection main optical head 3 separated from the augmented reality head-up controller host 4, such that the augmented reality head-up controller host 4 has a reduced volume (which may be generally designed to about 2 L, and has a significant volume change), thereby reducing space requirements for the interior of the dashboard 1, and further avoiding the problem of a poor imaging effect caused by poor heat dissipation of the augmented reality image projection main optical head 3. An air refractive index inside the augmented reality head-up controller host 4 may also be significantly improved due to the absence of a heating body, thereby improving the imaging quality to a certain extent. Furthermore, during imaging, the number of reflections of light emitted by the augmented reality image projection main optical head 3 inside the augmented reality head-up controller host 4 is reduced, thereby simplifying an imaging light path, and further improving the imaging quality.

With reference to FIG. 2, an augmented reality head-up display system for a vehicle of the disclosure is described in detail. FIG. 2 is a schematic structural diagram of an augmented reality head-up display system for a vehicle of the disclosure.

As shown in FIG. 2, in order to solve the above problem in the prior art, i.e., to solve the problem of an augmented reality head-up display system for a vehicle in the prior art usually having a large volume of an augmented reality head-up controller host, poor heat dissipation of an augmented reality image projection main optical head, a complex imaging light path, large space requirements for a dashboard, and poor imaging quality, the disclosure provides an augmented reality head-up display system for a vehicle. The vehicle comprises a dashboard 1, and the augmented reality head-up display system comprises an augmented reality image projection main optical head 3, an augmented reality head-up controller host 4, and a reflective imaging plate 2. The augmented reality head-up controller host 4 is arranged inside the dashboard 1, the augmented reality image projection main optical head 3 is arranged outside the dashboard 1, the dashboard 1 is further provided with a light path 5 capable of allowing for light to enter and exit the dashboard 1, and light emitted by the augmented reality image projection main optical head 3 can pass through the light path 5 to reach the augmented reality head-up controller host 4, continue to pass, through light reflection in the augmented reality head-up controller host 4, out of the light path 5 to reach the reflective imaging plate 2, and then achieve augmented reality head-up imaging through reflection of the reflective imaging plate 2.

With the above arrangement, the augmented reality head-up display system for a vehicle of the disclosure forms a complete light path by means of cooperation of the augmented reality image projection main optical head 3, the augmented reality head-up controller host 4, the reflective imaging plate 2 and the light path 5, such that the light emitted by the augmented reality image projection main optical head 3 can pass through the light path 5 to reach the augmented reality head-up controller host 4, continues to pass, through reflection of the augmented reality head-up controller host 4, out of the light path 5 to reach the reflective imaging plate 2, and forms an image through reflection of the reflective imaging plate 2, so as to facilitate viewing by the driver. Moreover, the augmented reality head-up controller host 4 is arranged inside the dashboard 1, the augmented reality image projection main optical head 3 is arranged outside the dashboard 1, so as to achieve separate arrangement of the augmented reality image projection main optical head 3 separated from the augmented reality head-up controller host 4, thereby reducing the volume of the augmented reality head-up controller host 4, so as to reduce space requirements for the interior of the dashboard 1, further avoiding the problem of a poor imagining effort caused by poor heat dissipation of the augmented reality image projection main optical head 3, and reducing the number of reflections of the light emitted by the augmented reality image projection main optical head 3 inside the augmented reality head-up controller host 4, and simplifying the imaging light path, so as to further improve the imaging quality.

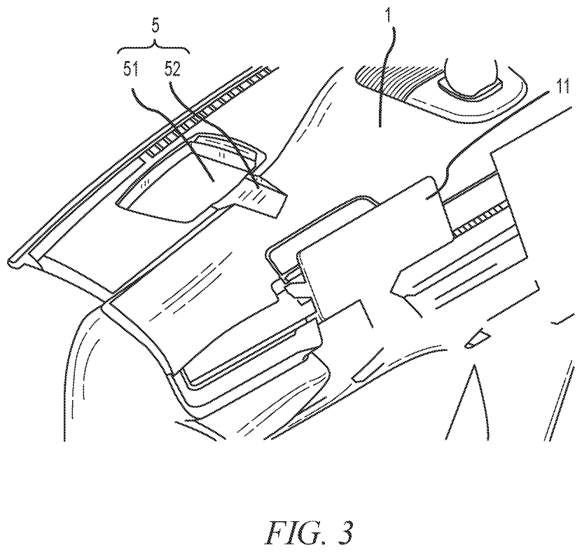

Further, with reference to FIGS. 2 and 3 below, the augmented reality head-up display system for a vehicle of the disclosure is described in detail.

As shown in FIGS. 2 and 3, in a possible implementation, a first instrument 11 is arranged on an outer side of the dashboard 1, and the augmented reality image projection main optical head 3 is arranged on a back surface of the first instrument 11.

With the above arrangement, the augmented reality head-up display system for a vehicle in this embodiment satisfies the requirements for arranging the augmented reality head-up controller host 4 inside the dashboard 1 and the augmented reality image projection main optical head 3 outside the dashboard 1 (that is, the augmented reality image projection main optical head 3 is arranged separately from the augmented reality head-up controller host 4) by arranging the augmented reality image projection main optical head 3 on the back surface of the first instrument 11, so as to reduce the volume of the augmented reality head-up controller host 4, thereby reducing space requirements for the dashboard 1, and further avoiding the problem of a poor imaging effect caused by poor heat dissipation of the augmented reality image projection main optical head 3. Furthermore, the light emitted by the augmented reality image projection main optical head 3 can be imaged on the reflective imaging plate 2 after being reflected once in the augmented reality head-up controller host 4. In this imaging process, the number of reflections of the light inside the augmented reality head-up controller host 4 is reduced, and the integral imaging light path is simplified, thereby improving the imaging quality.

As shown in FIG. 2, to facilitate adjustment of the position of a projected image in the reflective imaging plate 2, in this embodiment, the first instrument 11 is configured to be capable of translating or rotating.

With the above arrangement, thanks to the fact that the first instrument 11 is configured to be capable of translating or rotating, the position of the projected image in the reflective imaging plate 2 is convenient to adjust, thereby satisfying the requirements of a driver for adjusting the level of a horizontal position and a projection angle of the projected image, so as to satisfy use requirements of people having different heights or different seat heights.

It can be understood that although the arrangement position of the augmented reality image projection main optical head 3 is described by arranging the augmented reality image projection main optical head 3 on the back surface of the first instrument 11 as an example in this embodiment, the arrangement position of the augmented reality image projection main optical head 3 in this embodiment is not limited thereto, as long as the arrangement position enables a complete light path to be formed between the augmented reality image projection main optical head 3, the augmented reality head-up controller host 4, the reflective imaging plate 2 and the light path 5 so as to satisfy imaging requirements, and enables the augmented reality head-up controller host 4 to be arranged inside the dashboard 1, and the augmented reality image projection main optical head 3 to be arranged outside the dashboard 1, so as to separate the augmented reality image projection main optical head 3 from the augmented reality head-up controller host 4. For example, the augmented reality image projection main optical head 3 may be arranged on a fixed structure (not shown in the figures) on top of a head of the driver. For another example, the augmented reality image projection main optical head 3 may also be arranged on a translatable structure (not shown in the figures) on top of the head of the driver. For still another example, the augmented reality image projection main optical head 3 may be also arranged on a rotatable structure (not shown in the figures) on top of the head of the driver.

As shown in FIGS. 2-3, in order to improve the imaging quality of the projected image on the reflective imaging plate 2, in this embodiment, an auxiliary image projection following reflection plate 41 is arranged on the augmented reality head-up controller host 4, and the light emitted by the augmented reality image projection main optical head 3 pass, through reflection of the auxiliary image projection following reflection plate 41, out of the light path 5 to reach the reflective imaging plate 2.

With the above arrangement, the auxiliary image projection following reflection plate 41 is arranged on the augmented reality head-up controller host 4, to improve the focus accuracy of the augmented reality image projection main optical head 3 on the reflective imaging plate 2, so as to form a full-view reflected image, thereby improving the imaging quality of the projected image on the reflective imaging plate 2.

It should be noted that the full-view reflected image in this embodiment refers to an expanded imaging range, fro displaying .as much image information as possible on the reflective imaging plate 2.

As shown in FIG. 2, in order to further improve the imaging quality of the projected image on the reflective imaging plate 2, in this embodiment, a feedback camera 31 for auxiliary position adjustment is further provided on a side edge of the augmented reality image projection main optical head 3.

With the above arrangement, the augmented reality head-up display system for a vehicle in this embodiment is additionally provided with the feedback camera 31 for auxiliary position adjustment, so as to accurately track the quality of a focused image on the reflective imaging plate 2, to form continuous following control of the light path, thereby ensuring that the augmented reality image projection main optical head 3 can be accurately focused to the reflective imaging plate 2, so as to accurately focus the image to exclude ghosting defects of the image, thereby improving the imaging quality of the projected image on the reflective imaging plate 2.

It should be noted that in this embodiment, continuous following control of the light path refers to capturing an image of the real outside world by the feedback camera 31 in real time, comparing the image with an initial image on the reflective imaging plate 2 in real time, and performing real-time adjustment according to a comparison result, so as to accurately focus the image to exclude ghosting defects of the image, thereby improving the imaging quality of the projected image on the reflective imaging plate 2.

As shown in FIGS. 2-3, in a possible implementation, the reflective imaging plate 2 is a front windshield 21.

With the above arrangement, the light emitted by the augmented reality image projection main optical head 3 can pass through the light path 5 to reach the augmented reality head-up controller host 4, continues to pass, through reflection of the augmented reality head-up controller host 4, out of the light path 5 to reach the front windshield 21, and forms an image through reflection of the front windshield 21, such that the driver can view a clear and complete image on the front windshield 21.

In order to further increase the imaging resolution on the reflective imaging plate 2, in this embodiment, the reflective imaging plate 2 is a specular reflective film (not shown in the figures) attached to the front windshield 21.

In this embodiment, the reflective imaging plate 2 is configured as the specular reflective film and is attached to the front windshield 21, so as to further enhance a reflection effect of the light passing out of the light path 5 to reach the specular reflective film through reflection of the augmented reality head-up controller host 4, and to reduce a refraction effect, thereby further increasing the imaging resolution on the reflective imaging plate 2 and thus further improving the visual experience of the driver.

As shown in FIGS. 2-3, in a possible implementation, the dashboard 1 is an open dashboard (not shown in the figures), the light path 5 is configured to be provided with a notch 51 and a groove 52 on the open dashboard, and a piece of light transmitting glass (not shown in the figures) is arranged on the notch 51.

In this embodiment, the notch 51 is provided on the open dashboard, and the light transmitting glass is arranged on the notch 51, such that the light emitted by the augmented reality image projection main optical head 3 can enter the open dashboard through the notch 51, reach the augmented reality head-up controller host 4, and pass, through reflection of the augmented reality head-up controller host 4, out of the notch 51 to reach the reflective imaging plate 2, providing necessary hardware support for the light emitted by the augmented reality image projection main optical head 3 to enter and exit the open dashboard, such that the light can reach the augmented reality head-up controller host 4 and can be reflected by the augmented reality head-up controller host 4 to form an image. Moreover, in this embodiment, the provision of the groove 52 on the open dashboard provides a reasonable light avoidance effect, such that the light emitted by the augmented reality image projection main optical head 3 can better reach the augmented reality head-up controller host 4 in a process of entering the open dashboard and exiting the open dashboard, and the light reflected by the augmented reality head-up controller host 4 can better form an image on the reflective imaging plate 2, so as to further improve an imaging effect on the reflective imaging plate 2.

It should be noted that the open dashboard in this embodiment is a conventional closed dashboard provided with a notch 51 and a groove 52, so that the number of light beams entering and exiting the dashboard 1 is increased, thereby improving the imaging effect on the reflective imaging plate 2.

As shown in FIG. 2, in a possible implementation, the augmented reality head-up controller host 4 has a volume set in an interval ranging from 0.2 L to 5 L.

In this embodiment, thanks to the fact the augmented reality head-up controller host 4 has a volume set in an interval ranging from 0.2 L to 5 L, the volume of the augmented reality head-up controller host 4 is reduced to a certain extent, so as to reduce space requirements for the dashboard 1. Furthermore, the size of the projected image on the reflective imaging plate 2 is positively correlated to the volume of the augmented reality head-up controller host 4, the augmented reality head-up controller host 4 has the volume set in the interval ranging from 0.2 L to 5 L, and the volume of the augmented reality head-up controller host 4 is appropriately adjusted to increase the size of the projected image on the reflective imaging plate 2, thereby satisfying the requirements of a user for more display information. Moreover, the setting of the volume of the augmented reality head-up controller host 4 in the interval ranging from 0.2 L to 5 L improves a compactness effect of the augmented reality head-up controller host 4.

Thus, with the above arrangement, the size of the projected image on the reflective imaging plate 2 may be further considered while the volume of the augmented reality head-up controller host 4 is reduced, thereby better improving the user experience.

It should be noted that in this embodiment, the augmented reality head-up controller host 4 preferably has a volume of 2 L.

To sum up, the augmented reality head-up display system for a vehicle of the disclosure forms a complete light path by means of cooperation of the augmented reality image projection main optical head 3, the augmented reality head-up controller host 4, the reflective imaging plate 2 and the light path 5, such that the light emitted by the augmented reality image projection main optical head 3 can pass through the light path 5 to reach the augmented reality head-up controller host 4, continues to pass, through reflection of the augmented reality head-up controller host 4, out of the light path 5 to reach the reflective imaging plate 2, and forms an image through reflection of the reflective imaging plate 2, so as to facilitate viewing by the driver. Moreover, the augmented reality head-up controller host 4 is arranged inside the dashboard 1, the augmented reality image projection main optical head 3 is arranged outside the dashboard 1, so as to achieve separate arrangement of the augmented reality image projection main optical head 3 separated from the augmented reality head-up controller host 4, thereby reducing the volume of the augmented reality head-up controller host 4, so as to reduce space requirements for the interior of the dashboard 1, further avoiding the problem of a poor imagining effort caused by poor heat dissipation of the augmented reality image projection main optical head 3, and reducing the number of reflections of the light emitted by the augmented reality image projection main optical head 3 inside the augmented reality head-up controller host 4, simplifying the augmented reality imaging light path, and ensuring high-dynamic and high-pixel head-up projection imaging quality.

Moreover, thanks to the fact that the first instrument 11 is configured to be capable of translating or rotating, the position of the augmented reality projected image in the reflective imaging plate 2 is convenient to adjust, thereby satisfying the requirements of a driver for adjusting the level of a horizontal position and a projection angle of the augmented reality projected image, so as to satisfy use requirements of people having different heights or different seat heights.

Further, thanks to the fact that the auxiliary image projection following reflection plate 41 is arranged on the augmented reality head-up controller host 4 and the feedback camera 31 for auxiliary position adjustment is provided on the side edge of the augmented reality image projection main optical head 3, it is ensured that the augmented reality image projection main optical head 3 can be accurately focused to the reflective imaging plate 2, so as to accurately focus the image to exclude ghosting defects of the image, thereby improving the image quality of the projected image on the reflective imaging plate 2.

Moreover, thanks to the fact the augmented reality head-up controller host 4 has a volume set in an interval ranging from 0.2 L to 5 L, the volume of the augmented reality head-up controller host 4 is reduced to a certain extent, so as to reduce space requirements for the dashboard 1. Furthermore, the size of the projected image on the reflective imaging plate 2 is positively correlated to the volume of the augmented reality head-up controller host 4, the augmented reality head-up controller host 4 has the volume set in the interval ranging from 0.2 L to 5 L, and the volume of the augmented reality head-up controller host 4 is appropriately adjusted to increase the size of the projected image on the reflective imaging plate 2, thereby satisfying the head-up projection requirements of a user for more augmented reality display information.

It should be noted that the above implementations are only used to explain the principles of the disclosure, and are not intended to limit the scope of protection of the disclosure. Those skilled in the art can adjust the foregoing structures without departing from the principle of the disclosure, so that the disclosure is applicable to more specific application scenarios.

In addition, the disclosure further provides a vehicle having the augmented reality head-up display system for a vehicle of any one of the above implementations.

In addition, those skilled in the art should understand that although some embodiments described herein include certain features included in other embodiments, instead of other features, the combinations of the features of different embodiments mean to be within the scope of protection of the disclosure and form different embodiments. For example, in the claims of the disclosure, any one of the embodiments set forth thereby can be used in any combination.

Heretofore, the technical solutions of the disclosure have been described with reference to the preferred implementations shown in the accompanying drawings. However, those skilled in the art can readily understand that the scope of protection of the disclosure is apparently not limited to these specific implementations. Those skilled in the art can make equivalent changes or substitutions to the related technical features without departing from the principle of the disclosure, and all the technical solutions with such changes or substitutions shall fall within the scope of protection of the disclosure.

What is claimed is:

1. An augmented reality head-up display system for a vehicle, wherein the vehicle comprises a dashboard, and the augmented reality head-up display system comprises an augmented reality image projection main optical head, an augmented reality head-up controller host, and a reflective imaging plate, wherein the augmented reality head-up controller host is arranged inside the dashboard, the augmented reality image projection main optical head is arranged outside the dashboard, the dashboard is further provided with a light path capable of allowing for light to enter and exit the dashboard, and light emitted by the augmented reality image projection main optical head is capable of passing through the light path to reach the augmented reality head-up controller host, continuing to pass, through reflection in the augmented reality head-up controller host, out of the light path to reach the reflective imaging plate, and then achieving augmented reality head-up imaging through reflection of the reflective imaging plate.

2. The augmented reality head-up display system for a vehicle according to claim 1, wherein a first instrument is arranged on an outer side of the dashboard, and the augmented reality image projection main optical head is arranged on a back surface of the first instrument.

3. The augmented reality head-up display system for a vehicle according to claim 2, wherein the first instrument is configured to be capable of translating or rotating.

4. The augmented reality head-up display system for a vehicle according to claim 1, wherein an auxiliary image projection following reflection plate is arranged on the augmented reality head-up controller host, and the light emitted by the augmented reality image projection main optical head passes, through reflection of the auxiliary image projection following reflection plate, out of the light path to reach the reflective imaging plate.

5. The augmented reality head-up display system for a vehicle according to claim 4, wherein a feedback camera for auxiliary position adjustment is further provided on a side edge of the augmented reality image projection main optical head.

6. The augmented reality head-up display system for a vehicle according to claim 1, wherein the reflective imaging plate is a front windshield; or
the reflective imaging plate is a specular reflective film attached to the front windshield.

7. The augmented reality head-up display system for a vehicle according to claim 1, wherein the dashboard is an open dashboard, the light path is configured to be provided with a notch and a groove on the open dashboard, and a piece of light transmitting glass is arranged on the notch.

8. The augmented reality head-up display system for a vehicle according to claim 1, wherein the augmented reality image projection main optical head is arranged on a fixed structure, a translatable structure, or a rotatable structure on top of a head of a driver.

9. The augmented reality head-up display system for a vehicle according to claim 1, wherein the augmented reality head-up controller host has a volume set in an interval ranging from 0.2 L to 5 L.

10. A vehicle, comprising the augmented reality head-up display system for a vehicle of claim 1.

11. A vehicle, comprising the augmented reality head-up display system for a vehicle of claim 2.

12. A vehicle, comprising the augmented reality head-up display system for a vehicle of claim 3.

13. A vehicle, comprising the augmented reality head-up display system for a vehicle of claim 4.

14. A vehicle, comprising the augmented reality head-up display system for a vehicle of claim 5.

15. A vehicle, comprising the augmented reality head-up display system for a vehicle of claim 6.

16. A vehicle, comprising the augmented reality head-up display system for a vehicle of claim 7.

17. A vehicle, comprising the augmented reality head-up display system for a vehicle of claim 8.

18. A vehicle, comprising the augmented reality head-up display system for a vehicle of claim 9.
